(19) United States
(12) Patent Application Publication
(10) Pub. No.: US 2003/0111754 A1
(43) Pub. Date: Jun. 19, 2003

(54) Process for instructing an operator during maintenance and/or repair work on a tablet press

(76) Inventors: Jurgen Hinzpeter, Schwarzenbek (DE); Ingo Schmidt, Schwarzenbek (DE); Michael Neumann, Buchen (DE); Peter-Heinrich Lamp, Schwarzenbek (DE)

Correspondence Address: WALL MARJAMA & BILINSKI, 101 SOUTH SALINA STREET, SUITE 400, SYRACUSE, NY, 13202, US

(21) Appl. No.: 10/318,830

(22) Filed: Dec. 13, 2002

(30) Foreign Application Priority Data
Dec. 14, 2001 (DE) 101 61 570.1

(51) Int. Cl. B30B 11/00

(52) U.S. Cl. 264/39; 425/162; 425/344

(57) ABSTRACT

The present invention is directed to a process for instructing an operator during maintenance and/or repair work on a tablet press. The process is performed by a computer. The process includes selecting a tablet press function, whereby selection is read by the computer. A list of function sequences is output to an output device in accordance with the step of selecting. Each function sequence corresponds to repair/maintenance information pertaining to the selected tablet press function. A function sequence is selected from the list of function sequences. Finally, the selected sequence is output as a video sequence and/or an audio sequence.

### BACKGROUND OF THE INVENTION

1. Field of the Invention

The present invention relates generally to tablet-pressing systems, and particularly to a process for instructing an operator during maintenance and/or repair work on a tablet press.

2. Technical Background

A conventional tablet press includes a die-plate having a mould cavity formed therein to thereby define the tablet. The conventional press also includes an upper ram and a lower ram which are used to produce the tablet. As a rule, a tablet press is operated by two computer systems. One computer system is designed as a control or process computer which processes the high-speed measuring, controlling, and regulating processes on the tablet press in a real time. The second computer which is provided is a service computer. The service computer includes a man-machine interface that is configured to receive user-input commands, and graphically display process parameters, and logs processes. The service computer is also configured to perform static calculations on the executed processes.

In one approach that has been considered, a so-called “help” function is provided by the service computer. The help-function contains technical information about the tablet press in the form of textual information. An operator can deduce general information or indications from the texts regarding maintenance and repair work. One drawback to this approach is that it requires reading one or more texts with great care. This results in an excessive amount of lost time.

What is needed is a process for providing an operator with repair and maintenance information. It is therefore desirable that such a process be reliable, and at the same time, rapidly provide the operator with definitive instructions.

### SUMMARY OF THE INVENTION

The present invention addresses the aforementioned needs. The present invention is directed to a process for providing an operator with repair and maintenance information. The process of the present invention provides the operator with repair and/or maintenance instructions in a timely, efficient, and reliable manner.

One aspect of the present invention is a process for instructing an operator during maintenance and/or repair work on a tablet press. The process is performed by a computer. The process includes selecting a tablet press function, whereby selection is read by the computer. A list of function sequences is output to an output device in accordance with the step of selecting. Each function sequence corresponds to repair/maintenance information pertaining to the selected tablet press function. A function sequence is selected from the list of function sequences. Finally, the selected sequence is output as a video sequence and/or an audio sequence.

In the inventive process, data are read in on a function or process flow on the tablet press in a first step. Thus, for example, data on the rotor of the tablet press may also be read in during the first step without causing damage to the rotor and with no need to exchange it.

A list of auxiliary or service supports is generated and is output from an output device on the basis of the data which was read in. In a succeeding step, at least one of the auxiliary or service supports is selected, which subsequently is played back as a video sequence and/or audio sequence. Hence, after data was collected on the status of the tablet press the inventive process instructs the user both acoustically and optically. Such sequences which are played back are comprehensible far more easily than is a written text which exists, for example, in the form of questions and answers that is frequently used. The video sequences are used to show specific components which, for example, can only be described very clumsily, if at all, in a linguistic respect, in their positions in an easy manner. An acoustic instruction which the operator is given by an audio sequence has the advantage that if assembly and disassembly work is done on the tablet press an instruction can be given with no need for the operator to interrupt his/her work and to look at a screen or manual. It is preferred that either an audio sequence or a video sequence be employed, which depends on the nature of the maintenance and repair work to be performed. The precise instruction helps avoid downtimes and damage to the tablet press that could result from inexpert maintenance.

In a preferred aspect, input means are provided in response to an actuation of which the play-back of the video and/or audio sequence is stopped or continued. This enables the operator to play back the sequences in desired units and to interrupt them selectively.

It has proved beneficial to play back the video and/or audio sequences via a service computer for the tablet press. This avoids a further additional device on the tablet press. It is preferred that the audio and/or video sequences be saved in a database on a hard disk, CD-ROM and/or DVD. Here, the database may also be completed or single sequences thereof may be exchanged via remote data transmission. Thus, for example, successive audio sequences may be replaced with video sequences in the database via remote data transmission, which would make it unnecessary to install the database anew.

It is preferred to a particular extent that video and/or audio sequences be provided which contain explanations on how to assemble or disassemble modules and/or single components of the tablet press. Likewise, sequences may be provided which contain explanations on how to calibrate, install, and operate the tablet press. It is also possible to provide sequences which allow to remove malfunctions of the tablet press and to locate and describe the positions of determined components.

In a preferred aspect, a provision is made that in a case where the data in-putted do not allow to clearly determine video and/or audio sequences additional data is read in to make a selection of video and/or audio sequences. Additional data may also be read in if a list generated from the data already inputted would contain more than a maximum number of entries. The additional data are read in by a dialog procedure in which questions depending on the data which has been read in hitherto are outputted on the display device the answers to which are read in as additional data while the dialog procedure is continued until a selection is made for a video and/or audio sequence with reference to the data which was read in. The dialog procedure is preferably based on an expert system which performs a differential diagnosis for the tablet press by means of a predetermined decision tree and inquires of the operator the respective data relevant in determining the cause of a malfunction.

Another aspect of the present invention is a device for instructing an operator during maintenance and/or repair work on a tablet press. The device includes a user I/O device for inputting user data and outputting function sequence data. Each function sequence corresponds to repair/maintenance information pertaining to the selected tablet press function. A central processing unit (CPU) is coupled to the I/O device. The CPU is configured to generate a list of function sequence data, and display the list on a user display device. A replaying device reproduces a selected function sequence on a loudspeaker and/or a screen in response to a signal from the central processing unit. A memory device is coupled to the CPU, the memory device being configured to store the function sequences.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a block diagram of the tablet-pressing system in accordance with an embodiment of the present invention; and

FIG. 2 is a flow chart showing a process for instructing an operator during maintenance and/or repair work on a tablet press in accordance with the present invention.

### DETAILED DESCRIPTION

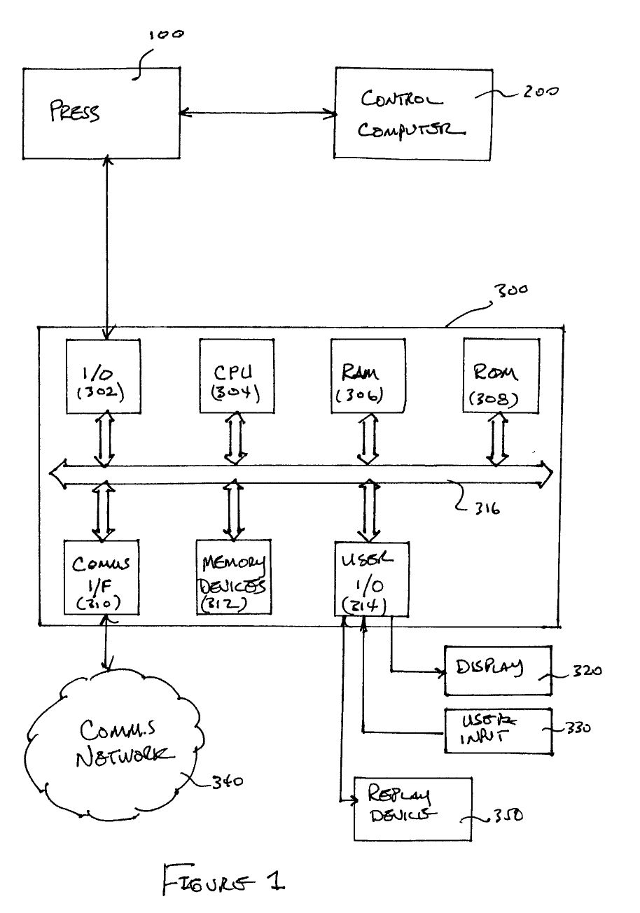

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the tablet-pressing system of the present invention is shown in FIG. 1, and is designated generally throughout by reference numeral 10.

In accordance with the invention, the present invention is directed to a process for instructing an operator during maintenance and/or repair work on a tablet press. The process is performed by a computer. The process includes selecting a tablet press function, whereby selection is read by the computer. A list of function sequences is output to an output device in accordance with the step of selecting. Each function sequence corresponds to repair/maintenance information pertaining to the selected tablet press function. A function sequence is selected from the list of function sequences. Finally, the selected sequence is output as a video sequence and/or an audio sequence. As such, the process of the present invention provides the operator with definitive repair and/or maintenance instructions in a timely, efficient, and reliable manner.

As embodied herein, and depicted in FIG. 1, a block diagram of the tablet-pressing system 10 in accordance with an embodiment of the present invention is disclosed. System 10 includes tablet press 100 coupled to control computer 200 and service computer 300. In one embodiment, the inventive process is embodied in service computer 300. Computer 300 includes I/O device 302 which coupled service computer 300 to press 100. Computer 300 may also include a central processing unit (CPU) 304, a replaying device 350, RAM 306, ROM 308, communications interface 310, user I/O 314, and a memory device 312. Replay device 350 plays back selected audio and/or video sequences which are stored on the memory device.

It will be apparent to those of ordinary skill in the pertinent art that processor 304 may be of any suitable type depending on the functionality and sophistication of the firmware resident in ROM 308. In one embodiment, microprocessor 300 is an off-the-shelf VLSI integrated circuit (IC) microprocessor manufactured by Intel, AMD, Motorola or some other such IC manufacturer that is chosen based on the aforementioned criteria.

Memory 306 may be of any suitable type, but by way of example, memory 306 includes a read/write random access memory (RAM) used in data processing and data I/O. ROM 308 is used to store programming instructions used by processor 304. One of ordinary skill in the art will recognize that ROM 308 used to store the programming instructions may be implemented using a DRAM, PROM, EPROM, or EEPROM. Memory device(s) 312 also may be of any suitable type, including a hard drive, floppy diskettes, a compact disk device, DVD drive.

Communications interface 310 is provided to link the memory device to an external telephone computer network in order that new audio and/or video sequences may be transmitted to the memory device.

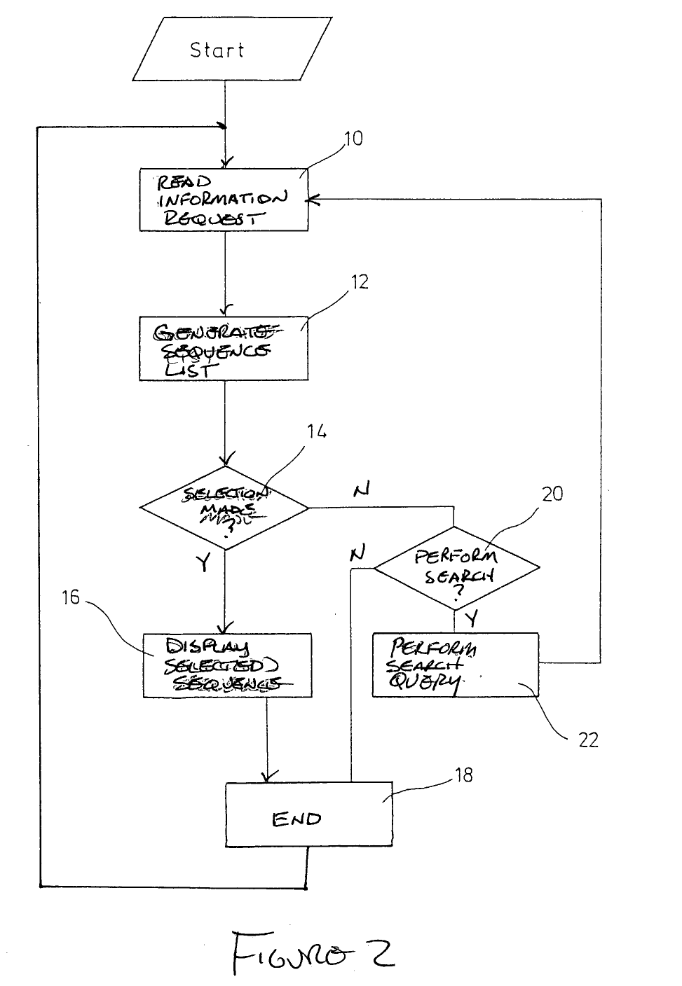

As embodied herein, and depicted in FIG. 2, a flow chart showing a process for instructing an operator during maintenance and/or repair work on a tablet press in accordance with the present invention is disclosed. At the start of the process, first information is read in during a process step 10. The information request corresponds to the repair/maintenance information the operator is seeking guidance for. For example, the operator may input the word “Rotor”. In step 12, a list is generated as a result of the aforementioned information request 10. The list includes the rotor sequences that exist in the database, e.g. rotor disassembly, rotor damage, rotor cleaning and the like. If the operator makes a selection in a succeeding step 14, the sequence which was selected is displayed in step 16. If the selection includes video, it may be displayed on display device 320. If the selection is audio, it may be presented using replay device 350. The video and/or audio sequences are saved in a database on memory device 312, e.g., a hard disk, CD-ROM and/or DVD. The process ends in the subsequent step 18 and the service computer will be ready again.

If no selection is made in process step 14, a search may be offered in step 20. A search 20 is useful in finding causes of problems in the overall process flow. Subsequent to the search inquiry 20, a question is presented in a process step 22 and the answer to this question is read in during process step 10 that follows. Now that the question is answered another list may now be generated and displayed in a process step 12. If the operator wishes to continue the search a branching to the search has to be made in process step 14 in this aspect of the dialog procedure.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A process for instructing an operator during maintenance and/or repair work on a tablet press, the process being performed by a computer, the process comprising:
selecting a tablet press function, whereby selection is read by the computer;
outputting a list of function sequences to an output device in accordance with the step of selecting, each function sequence corresponding to repair/maintenance information pertaining to the selected tablet press function;
selecting a function sequence from the list of function sequences; and
outputting the selected sequence as a video sequence and/or an audio sequence.

2. The process of claim 1, further comprising the step of providing input means, in response to an actuation of said input means, the play-back of the video and/or audio sequence is stopped or continued.

3. The process of claim 2, characterized in that the video and/or audio sequence is played back via a service computer for the tablet press.

4. The process of claim 3, characterized in that the video and/or audio sequences are saved in a database on a hard disk, CD-ROM and/or DVD.

5. The process of claim 4, wherein the sequences may be obtained from the database or from a data transmission from a remote location.

6. The process as claimed in any one of claims 1 to 5, characterized in that video and/or audio sequences are provided which contain explanations on how to assemble or disassemble modules and/or single components of the tablet press.

7. The process of claim 1, wherein video and/or audio sequences are provided, the video and/or audio sequences including explanations on how to calibrate, install, and operate the tablet press.

8. The process of claim 1, wherein video and/or audio sequences are provided, the video and/or audio sequences including explanations on how to remove malfunctions during process flows and locate predetermined components.

9. The process of claim 1, wherein selecting a tablet press function further comprises the steps of:
querying the user for additional data if the computer cannot determine which function sequence to output in response to the step of selecting a tabletpress function;
inputting the additional data from the user; and
output a list of video and/or audio sequences in accordance with the step of inputting.

10. A device for instructing an operator during maintenance and/or repair work on a tablet press, the device comprising:
a user I/O device for inputting user data and outputting function sequence data, each function sequence corresponding to repair/maintenance information pertaining to the selected tablet press function;
a central processing unit (CPU) coupled to the I/O device, the CPU being configured to generate a list of function sequence data, and display the list on a user display device;
a replaying device which reproduces a selected function sequence on a loudspeaker and/or a screen in response to a signal from the central processing unit; and
a memory device coupled to the CPU, the memory device being configured to store the function sequences.

12. The device of claim 11, wherein the computer is a service computer for the tablet press system.

13. The device of claim 11, wherein the memory device is a hard disk, CD drive and/or DVD drive.

14. The device of claim 11, further comprising a communications interface configured to couple the central processing unit to an external computer or telephone network.
